(19) United States
(12) Patent Application Publication
(10) Pub. No.: US 2006/0040122 A1
(43) Pub. Date: Feb. 23, 2006

(54) Antimicrobial drywall

(75) Inventors: Paul E. Carlson, Pittsburgh, PA (US); H. Edwin Nehus, Pittsburgh, PA (US)

Correspondence Address: William L. Krayer, 1771 Helen Drive, Pittsburgh, PA, 15216, US

(73) Assignee: Verichem, Inc.

(21) Appl. No.: 11/206,717

(22) Filed: Aug. 18, 2005

Related U.S. Application Data
(60) Provisional application No. 60/603,075, filed on Aug. 20, 2004.

(51) Int. Cl. B32B 37/00; B32B 29/00; B32B 13/00

(52) U.S. Cl. 428/537.7; 156/44; 428/703

(57) ABSTRACT

Antimicrobial guanidine compounds are used, either alone or with at least one other antimicrobial compound, to make mildew-resistant wallboard. Particularly useful co-additives are o-phenyl phenol and sodium methyldithiocarbamate. The antimicrobial compound(s) may be added to the covering, the core body, an adhesive at the interface of the core body and the covering, or all three of these sites. A preferred guanidine compound is dodecyl guanidine hydrochloride.

### RELATED APPLICATION

This application claims the full benefit under 35USC119 and/or 120 of provisional application 60/603,075 filed Aug. 20, 2004.

### TECHNICAL FIELD

The invention relates to wallboard, sometimes known as drywall or gypsum board, constructed or treated to resist mildew and the growth of other undesirable microorganisms. In particular, the wallboard is treated with a mildew-inhibiting guanidine compound, alone or together with another compound which may result in synergistic mildew-inhibiting effects.

### BACKGROUND OF THE INVENTION

Wallboard is widely used in home and other building construction, almost entirely for internal walls and ceilings. It is fire resistant, inexpensive compared to other types of interior wall panels, is readily installed, can be cut and shaped to conform to needs at the site of installation, and is easily decorated with paint or wallpaper. Wallboard does, however, sometimes attract and retain moisture, which can lead to unsightly and unhealthful growths of microorganisms, most notably the fungi which cause mildew.

Recently, significant economic losses have been experienced due to the spread of mold and mildew throughout entire buildings, resulting in the necessity to evacuate the buildings at least partly because of health risks, remove the infected wallboard, treat the uncovered framework to discourage further growth, and replace the interior walls and ceilings throughout the buildings. There is a need to guard against such economic losses and health risks by providing wallboard which is resistant to fungus, mold, and mildew growth.

Wallboard is typically made of powdered dehydrated gypsum formed into a slurry or paste and spread on a paper backing. When the water in the paste or slurry contacts the powdered dehydrated gypsum, the gypsum hardens while absorbing the water; it then is covered with another sheet of paper and, after a predetermined degree of hardness is achieved, the sheet is passed into an oven for drying. Inexpensive adhesives such as starch are frequently used to assure that the paper backing adheres to the gypsum core. Starch tends to be water soluble, and the paper backing on both sides of the wallboard may also be water-absorbent, although it is not uncommon to treat the paper to increase its water resistance. Dispersants and other chemicals can be used in the gypsum slurry to enhance the spreading process and/or workability of the slurry or paste during the wallboard formation process. While the gypsum should be fully hydrated, there may be instances where it is able to attract moisture itself; also the fibers of the paper may be hydrophilic. The final product is hardly ever fully immune to the adsorption of at least some moisture, and it is this moisture, along with nutrients available from the paper, starch, and other organic ingredients, that may help to form an environment hospitable to mold, fungi, and mildew. Even hydrophobic materials such as spun-bond polypropylene, glass fibers, and various inorganic fillers, when used as additives to the wallboard, and even wicking materials used to draw moisture out of the wallboard may harbor moisture on their surfaces or in their voids. Until such time as a completely and permanently dry drywall is developed, a method of inhibiting the growth of fungi in wallboard is needed in the industry.

The reader may be interested in Regutti's U.S. Pat. No. 3,264,172, describing a bacteriostatic tissue paper made with guanidine salts.

U.S. Pat. No. 6,767,647 to Swofford et al, entitled “Antimicrobial Wallboard,” contains several paragraphs discussing prior patents which have suggested various approaches to constructing antimicrobic drywall. In particular, the Swofford et al patent reviews descriptions of the incorporation of biocides into the gypsum slurry or paste and in the pulp used for the paper covering. It also describes topical methods of application of biocides, such as spraying or coating by rollers, calenders, or the like; for example, in Long U.S. Pat. No. 3,918,981. The Swofford et al patent 6,767,647 is incorporated herein by reference in its entirety. See also Capps U.S. Pat. Nos. 6,680,127 and 6,773,822, both titled “Antifungal Gypsum Board,” which are also incorporated herein by reference in their entireties. These patents describe the manufacture of wallboard in somewhat different terms than the Swofford et al patent, noting, for example, different types of facings (coverings herein) for the front and back of the gypsum board. The Capps patents recite long lists of quaternary ammonium compounds which are said to be effective antifungal agents in wallboard. Applicants' guanidines are entirely compatible with these quaternary compounds, including Capps' preferred cetyl pyridinium chloride.

### SUMMARY OF THE INVENTION

Our invention incorporates certain guanidine compounds as effective against microorganisms such as bacteria and mold, and particularly mildew-causing fungi, in wallboard when used alone or together with other antimicrobial agents. The guanidine compound, with or without another antimicrobial agent, may be incorporated into or onto the gypsum slurry or paste in the early stages of wallboard formation, incorporated into the paper used for the covering of the gypsum, incorporated into the starch or other organic or inorganic adhesive that is used to bind the paper to the gypsum core, sprayed or coated on the gypsum core prior to application of the adhesive or starch, or sprayed or coated on the paper and/or the joint compound after the parts of the wallboard are assembled. Having our mildew-inhibiting composition on the exterior of the paper layer will minimize the potential for mildew growth where wallpaper is applied using organic paste, which also may be a source of nutrition for fungi.

In using the term “paper,” we intend to include any non-woven, primarily cellulosic, material. Commonly the paper will have a weight of about 40-90 pounds per 1000 square feet, but we are not limited to these weights. However, our invention includes wallboards having coverings or facings of hydrophobic or non-nutritive materials such a spun-bond polypropylene sheets, used as coverings or facings. Our invention may be used in any such modified wallboard. A wallboard within our invention may, for example, have a paper covering or facing on one side and a spun-bond polypropylene facing on the other side. By a “covering” is meant any substantially continuous facing or covering for the core body, porous or not porous. It is commonly paper.

The term “core body” as used herein includes the presently common, substantially monolithic, gypsum core as described in the Swofford et al and Capps patents identified above, and also includes similar cores containing minor or substantial amounts of other inorganic and/or substantially insoluble or hydrophobic materials which may be in particulate or fibrous form. These materials may be formed into a semi-rigid mass by a binder or by curing, fusing, or by compression, all possibly in the presence of the gypsum slurry or paste or otherwise in the incipient core. We do not intend to be limited in the materials of construction of the core body, and accordingly the term “core body” is meant to include not only the common gypsum core, but any practical substitute therefor or modification thereof.

The guanidine mildew-inhibitor may be chosen from any guanidine that is approved by the US Department of Environmental Protection as a microbiocide, now or in the future. Among the chemicals approved at the time of this application are (1,1,3,3-tetramethylbutyl) guanidine; 1,1-(iminobis(octamethylene))diguanidine sulfate; 1,1-(iminobis(octamethylene))diguanidine; dodecylguanidine acetate; cyanoguanidine and derivatives; dodecyl guanidine terephthalate; N,N′″-(iminodi-8,1-octanediyl)bis-guanidine; N,N′″-1,6-hexadiylbis-guanidine homopolymer hydrochloride; N,N′″-1,8-octanediylbis-guanidine; N-methyl-N″nitro-N″-[tetrahydro-3-furanyl)methyl]guanidine; methylmercuric cyanoguanidine; N-methyl-N′-nitro-N-nitrosoguanidine; nitroguanidine; terephthalic acid compounded with dodecylguanidine. Generally, the alkyl guanidines may be found commercially in association with anions of hydrochloric acid, acetic acid, and terephthalic acid, but any suitable counterion may be used. Dodecyl guanidine hydrochloride has been approved for many years and has been proposed for use in many different contexts. The acetate and terephthalate forms of dodecyl guanidine are also useful in our invention, as are other alkyl guanidine hydrochlorides, acetates and terephthalates wherein the alkyl group has from 8 to 20 carbon atoms. Again, any compatible counterion may be used with the guanidine moiety. As is known in the art, commercial dodecyl guanidine hydrochloride may contain significant amounts of alkyl analogs having numbers of carbon atoms other than 12. See also, for example, the DGH preparation described by Matz and Richardson in U.S. Pat. No. 5,532,413. Additional antimicrobial compounds are described by Pelcak et al in U.S. Pat. No. 2,906,595, issued in 1959. Both the Matz et al patent and the Pelcak et al patent are incorporated herein by reference in their entireties. Dodecyl guanidine hydrochloride, in its pure or commercial form containing other alkyl groups, may be referred to herein as “DGH.” The guanidines described in this paragraph—that is, guanidine compounds having a mildew-inhibiting effect—may be referred to herein simply as “guanidine” or “guanidines,” or an “antimicrobial guanidine compound.”

By “antimicrobial,” we mean that the compounds described or named are able to repress or inhibit the growth of microorganisms, or are lethal to them. In repressing or inhibiting the growth of the microorganisms, they will usually demonstratively limit the growth of colonies and individual monocellular organisms as compared to a control. We may include some multicellular organisms or colonies as the target of antimicrobial activity. For example, various types of molds and other organisms form colonies quite visible to the naked eye which are commonly known as mildew; these colonies are multicellular in the broad sense but the inhibition of growth, reproduction, and/or spread is generally accomplished on a monocellular, and hence microscopic, level. We may use the term “microbes” interchangeably with “microorganisms.”

Ortho phenyl phenol also has an excellent record of efficacy against microbes, and is commonly also used in its sodium salt form. When we refer to o-phenylphenol herein, we may substitute sodium o-phenylphenate, and we intend to include them both when we use the term “OPP”; either may be used in our invention in combination with the guanidine compound. Alternatively, we may substitute other phenolic compounds known to have antimicrobial effects, including p-chloro-m-cresol, benzyl-phenol, p-chloro-o-benzyl-phenol, (2,2-dihydroxy-5,5′dichloro-)diphenyl methane, p-chloro-m-xylenol, and pentachlorophenol. Collectively, these and o-phenylphenol and its sodium salt (OPP), as well as any other antimicrobial phenolic compound, may be referred to herein as “antimicrobial phenolic compounds.”

A preferred combination of antimicrobial agents we may use comprises (a) orthophenylphenol or its sodium salt, sodium orthophenylphenate and (b) an antimicrobial guanidine compound. A convenient combination is OPP and DGH; a convenient weight concentration ratio of OPP to DGH may be 2000:1 to 1:2000. The OPP and guanidine are most conveniently prepared and used in the same liquid composition. Compositions containing both OPP and guanidine may be referred to herein as a “guanidine antimicrobial composite.” It should be noted that one need not use the guanidine antimicrobial composite. That is, a combined effect may be achieved, for example, where one antimicrobial compound is introduced to a paper covering and the other is added to a gypsum slurry or paste for making the core body; one may be applied in the adhesive and the other applied topically to the finished wallboard. However, we believe the synergistic effects of a DGH/OPP combination are best achieved where both are present in the same liquid antimicrobial composite and added to at least one of the components of the wallboard.

Another compound shown to be particularly effective when used with a guanidine is sodium methyldithiocarbamate, sometimes referred to herein as “NaMetam.” Where both DGH and NaMetam are used, the combination may also be called a “guanidine antimicrobial composite.” Any system wherein both a guanidine compound and another antimicrobial compound is used may be referred to herein as a “guanidine antimicrobial composite.”

### DETAILED DESCRIPTION OF THE INVENTION

The antimicrobial additive (that is, a guanidine alone, or a guanidine antimicrobial composite) may be included in the gypsum slurry or paste, or it may be included in the pulp used to make paper, or in a liquid component of the paper, such as with a dispersant, flocculant, retention aid, coupling agent or other additive, as well as simply in the water added or applied during the papermaking process, although it may be wasteful to use it at a stage prior to a draining or compressing which would lead to expulsion of some of the antimicrobial composite. Or, it may be included with the starch, adhesive medium, or other material used between the paper and the gypsum core. It may be incorporated into the covering, core body, or other wallboard component with a controlled release agent to assure its effectiveness over time or when a precalculated degree of moisture is present. It may be applied by spraying, roll-coating or otherwise applying to the paper surface before or after it is placed on the gypsum core. For example, the paper may be made in a facility separate from that in which it is placed on the core; the antimicrobial additive may be applied topically in either facility. If it is sprayed, the paper need not be completely formed or dried at the time of spraying. If it is roll-coated, it may be applied in calendars or rolls present in the existing papermaking machinery, either separately or added to water used to dampen or treat the semifinished paper. The DGH and OPP, or DGH and NaMetam, or DGH and another antimicrobial ingredient of a guanidine antimicrobial composite, may be used separately, but for the most beneficial effects, they should both be present in one or more of the same components of the wallboard.

When used by itself, any amount of antimicrobial guanidine compound present anywhere in the finished wallboard will have at least some antimicrobial effect. Where it is used in the paper, a convenient amount will be at least 10 parts by weight per million parts by weight of the finished paper; where it is used in the gypsum, 10 parts per million is also a convenient amount; likewise in the starch or other material used in the interface between the gypsum and the paper. If it is applied topically by spraying or coating after formation of the completed wallboard, the spray or coating solution may contain at least 10 parts guanidine compound and be applied in a coating at least thick enough to be visible to the naked eye. The antimicrobial guanidine compound will then be present on the surface of the paper.

Likewise when the guanidine compound is combined with OPP or other antimicrobial compound, any amount of the antimicrobial composite present anywhere in the finished wallboard or in more than one component, will have at least some antimicrobial effect. Where it is used in the paper, a convenient amount will be at least 10 parts by weight per million parts by weight of the paper; where it is used in the gypsum, 10 parts per million is also a convenient amount; likewise in the starch or other material used in the interface between the gypsum and the paper. If it is applied topically by spraying or coating after formation of the completed wallboard, the spray or coating solution may contain at least 10 parts per million guanidine compound and be applied in a coating at least thick enough to be visible to the naked eye. The antimicrobial guanidine compound and the OPP (or other antimicrobial compound, if used) will then be present on the surface of the paper.

Our antimicrobial guanidine compound may be used in a formulation designed to avoid foaming, such as described in Marks et al U.S. Pat. No. 3,143,459, also incorporated herein by reference in its entirety. OPP, NaMetam, or other antimicrobial, may be added to such compositions to form a non-foaming guanidine antimicrobial composite. Again, the weight ratio of DGH:OPP or DGH:NaMetam may conveniently range from 1:2000 to 2000:1, although any effective ratio may be used.

This invention includes synergistic ratios of guanidine compounds and o-phenylphenol or sodium orthophenylphenate. Generally, any ratio of guanidine compound to OPP within the range of 1:2000 to 2000:1 by weight will be effective to some degree, but we prefer to use the most efficient combinations, as seen below. We have found that mixtures of guanidine compounds and o-phenylphenol can demonstrate synergistic effects as compared to either of the two ingredients used separately against mixed cultures of gram positive and gram negative organisms as well as known mildew-producing organisms.

We include in our invention combinations of orthophenylphenol or sodium orthophenylphenate with guanidine compounds other than dodecyl guanidine hydorchloride. In addition to alkyl guanidines wherein the alkyl group contains 8 to 18 carbon atoms, we include any guanidine compound known to be an effective microbiocide and especially those compounds listed above as approved for use by the US Environmental Protection Agency: Generally, the alkyl guanidines may be found commercially in association with anions of hydrochloric acid, acetic acid, and terephthalic acid. All such compositions are included in our invention. For the sake of convenience, we refer to the known antimicrobial guanidines as microorganism growth-inhibiting guanidines.

O-phenylphenol was tested in combination with DGH. The synergism of the blends was determined using a dose protocol. The combinations were evaluated in synthetic white water with pH value of 5.5. The materials were tested against an artificial bacterial consortium containing approximately equal numbers of six bacterial strains. Although the test strains are representative of organisms present in paper mill systems, the effect is not limited to these bacteria. Two of the strains were Kiebsiella pneumoia (ATCC 13883) and Pseudomonas aeruginosa (ATCC 15442). The other four strains were isolated from papermill systems and have been identified as Curtobacterium flaccumfaciens, Burkhlderia cepacia, Bacillus maroccanus, and Pseudomonas glethei. Each strain was inoculated at 37° C. overnight, then suspended in sterile saline. Equal volumes of each strain were then combined to prepare the consortium. The bacterial consortium was distributed into the wells of a microliter plate in the presence or absence of various concentrations of the active materials. The microliter plates were incubated at 37° C. Optical density (O>D>) readings at 650 nm were taken initially (t₀) and after 4 hours (t₄) of incubation.

The raw data were converted to “bacterial growth inhibition percentages” according to the following formula:
% inhhibition=[(a−b)/a]·100
where

a=(O.D. of control at tₙ)−(O,D. of control at t₀)

b=(O.D. of treatment at tₙ)−(O,D. of treatment at t₀).

The inhibition values can be plotted versus dosage for each active and the particular blend. This results in a dose response curve from which the dosage to yield 50% inhibition (l₅₀) can be calculated. In the examples (tables) below, the ₅₀ values are expressed as parts per million (ppm) of active material.

The synergism index (SI) was calculated by the equation below, which was proposed by F. C. Kull, P. C. Eisman, H. D. Sylwestrowicz, and R. L. Mayer (1961) Applied Microbiology 9, 538-541. The values are based on the amount needed to achieve a specified end point. The end point selected for these studies was 50% inhibition of bacterial growth.
Synergy Index (SI)=(QA/Qa)+(QB/Qb)
where

QA=quantity of compound A in mixture, producing the end point

Qa=quantity of compound A₁ acting alone, producing the end point

QB=quantity of compound B in mixture, producing the end point

Qb=quantity of compound B₁ acting alone, producing the end point If SI is less than 1, synergism exists; if SI is greater than 1, antagonism exists; if SI is equal to 1, an additive effect exists.

Guanidine compounds form synergisitc blends with OPP. To test this hypothesis, mixtures of DGH and OPP were tested:

### Dodecyl Guanidine Hydrochloride and Ortho Phenyl Phenol

This example shows synergistic activity between OPP and dodecylguanidine hydrochloride when fed simultaneously in a bacterial consortium in water at pH 5.5. The synergistic range may be defined as a weight ratio of DGH:NaOPP of 1:150 to 1:1500.

DGH* & NaOPP
@ pH 5.5

| Ppm | ppm | | Synergy |
|---|---|---|---|
| DGH | NaOPP | Ratio DGH:NaOPP | Index |
| 1.75 | 0.00 | 100:0 | 1.00 |
| 2.11 | 3.91 | 1.0:1.8 | 1.23 |
| 2.03 | 7.81 | 1.0:3.8 | 1.21 |
| 1.88 | 15.63 | 1.0:8.3 | 1.17 |
| 1.67 | 31.25 | 1.0:18.7 | 1.15 |
| 1.25 | 61.07 | 1.0:48..9 | 1.09 |
| 1.26 | 62.50 | 1.0:49.6 | 1.10 |
| 0.63 | 102.81 | 1.0:164.5 | 0.98 |
| 0.31 | 119.42 | 1.0:382.1 | 0.91 |
| 0.16 | 124.01 | 1.0:793.7 | 0.85 |
| 0.08 | 166.72 | 1.0:2134.0 | 1.06 |
| 0.04 | 179.85 | 1.0:4604.1 | 1.12 |
| 0.02 | 169.95 | 1.0:8701.5 | 1.05 |
| 0.01 | 176.28 | 1.0:18051.1 | 1.08 |
| 0.00 | 163.91 | 0:100 | 1.00 |

*DGH - Dodecylguanidine Hydrochloride

The methodology and the Synergy Index to be found in the Kull et al article have become benchmarks in the field and are widely accepted among persons skilled in the microbiocide art. The test enables a convenient determination whether reduced concentrations of antimicrobial compounds can produce equivalent or superior antimicrobiocidal effects. If the value produced by the formula is less than 1, the combined ingredients are considered synergistic. It does not matter what the value is as long as it is less than 1.

As a further demonstration of the synergistic propensities of combinations of dodecyl guanidine hychloride and ortho phenylphenol, tests were conducted on certain fungi, and the results are presented in Table 1. The procedure followed is adapted from and follows very closely, the procedure described in the Kull et al article. The concentrations listed in Table 1 are the Minimum Inhibitory Concentrations.

TABLE 1

| | Concentration | | Concentration | | |
|---|---|---|---|---|---|
| | of OPP in | Concentration | of DGH in | Concentration | K |
| Organism | combination | of OPP alone | combination | of DGH alone | value |
| Penicillium | 1.95 | 15.6 | 50 | 62.5 | 0.9 |
| pinophillum | | | | | |
| Aspergillus | 1.95 | 15.6 | 50 | 62.5 | 0.9 |
| niger | | | | | |
| Wild strain - | 1.95 | 15.6 | 50 | 125 | 0.5 |
| Alternaria | | | | | |
| sp. | | | | | |
| Mixed | 1.95 | 15.6 | 50 | 125 | 0.5 |
| inoculum | | | | | |

As seen above, the ratio of OPP:DGH of 1:26 enables the use of less material to obtain the same results as significantly greater concentrations of either OPP or DGH alone. As the Minimum Inhibiting Concentration will vary from organism to organism, the optimum ratio of OPP:DGH will vary also, but the K values for Penicillum pinophillum and Aspergillis niger are definitely synergistic.

In addition to experiments as described above, tests were made to compare combinations of DGH (dodecyl guanidine hydrochloride) and OPP against microorganisms known to generate what is commonly known as mildew, when used in caulking and/or adhesive materials used in bathtubs, showers and the like. ASTM (American Society for Testing Materials) Test Method D-3273 00, dealing with resistance to surface mold fungi and mildew was used. Generally, this is an accelerated test calling for a test chamber held at a relative humidity of 95 to 98% and a temperature of 32.5±1° C. (90±2° F.).

Five commercial adhesive compositions known to be susceptible to mildew growth were tested using the microorgainsms Aureobasidium pullulans ATCC 9348, Aspergillus niger ATCC 6275, Penicillium sp. ATCC 9849. Table 2 below shows the results of the susceptibility test using the commercially available materials without modification.

TABLE 2
Mildew Susceptibility

| Sample Identification | 7 days | 14 days | 21 days | 28 days |
|---|---|---|---|---|
| Ponderosa Pine (control) | 5 | 0 | 0 | 0 |
| Titebond ™ Professional | 10 | 10 | 8 | 8 |
| Tub Surround | | | | |
| Titebond ™ Solvent Free | 10 | 10 | 8 | 7 |
| Construction Adhesive | | | | |
| Titebond ™ Professional | 10 | 10 | 9 | 9 |
| Drywall Adhesive | | | | |
| Titebond ™ Solvent Free | 7 | 4 | 0 | 0 |
| Subfloor Adhesive | | | | |
| Titebond ™ solvent Free | 7 | 4 | 0 | 0 |
| Fast Grab FPR Adhesive | | | | |

10 = No mildew growth; excellent mildew resistance.
7-9 = Trace mildew growth; very good mildew resistance
6-5 = Moderate mildew growth; poor mildew resistance
4-0 = Heavy mildew growth; failed.

Varying degrees of mildew resistance are demonstrated in the above Table 2.

Following this test, a composition comprising 10 g of OPP and 30 g of dodecyl guanidine hydrochloride (DGH) was incorporated into samples of Titebond™ Professional Tub Surround Adhesive at concentrations of 150, 250, 500, 750, and 1000 ppm and the adhesive was tested in the same manner as in Table 2. At 28 days, all of the DGH/OPP compositions were rated at 10. Similar additions (150, 250, 500, 750, and 1000 ppm) to Titebond Professional Drywall Adhesive also resulted in ratings of 10 at 28 days, although it should be noted that both the commercial dry wall adhesive and the tub surround adhesive were deemed only slightly vulnerable to mildew growth. Using the same organisms in similar tests, DGA (dodecyl guanidine acetate) alone, DGH alone, and combinations of DGH and OPP have also been shown to be effective mildew inhibitors in two common construction adhesives, Titebond™ Solvent Free Fast Grab FRP Adhesive, and Titebond™ Solvent Free Subfloor Adhesive.

Again, smaller quantities of the DGH/OPP composition were more effective against mildew for longer periods of time than the other microbiological growth inhibitors. It should be noted here that the adhesives and similar materials tested in the experiments reported above are representative of a large class of adhesives and similar materials used in the construction industry and elsewhere.

In Table 3, synergism test results are summarized for a 1:26 weight ratio of OPP:DGH against three molds, using the same test system as for Table 1

TABLE 3
Synergy results for 1:26 OPP:DGH

| | OPP conc | OPP conc | DGH conc | DGH conc | |
|---|---|---|---|---|---|
| | (ppm) in | (ppm) | (ppm) in | (ppm) | K |
| Organism | combination | alone | combination | alone | value |
| Penicillum | 1.95 | 15.6 | 50 | 62.5 | 0.9 |
| pinophillum | | | | | |
| Aspergillus | 1.95 | 15.6 | 50 | 62.5 | 0.9 |
| niger | | | | | |
| Wild strain - | 1.95 | 15.6 | 50 | 125 | 0.5 |
| Atlernaria | | | | | |
| sp. | | | | | |
| Mixed | 1.95 | 15.6 | 50 | 125 | 0.5 |
| inoculum | | | | | |

The results clearly show synergism.

It is known in the art that dodecyl guanidine hydrochloride is seldom manufactured in a 100% pure form. In particular, the alkyl group is seldom entirely dodecyl; rather, the presence of similar compounds is common where the number of carbon atoms may differ 2, 3, or more carbon atoms more or less from twelve, meaning that while the actual product may contain predominantly the dodecyl species, other similar compounds may be present in relatively large percentages. Such commercially common compositions are included in our invention, and it should be understood that the term “dodecyl guanidine hydrochloride” includes such mixtures which may include molecules having up to 20 or more atoms in the alkyl group, and any other commercial variants.

### Dodecyl Guanidine Hydrochloride and Sodium Methyl Dithiocarbamate

Synergism has also been shown for combinations of DGH and NaMetam (sodium methyldithiocarbamate). The Table 5 results were obtained in a manner similar to those of Table 1:

TABLE 5
Synergy Calculation for NaMetam:DGH

| | Conc of | | | | |
|---|---|---|---|---|---|
| | NaMetam | Conc of | Conc. Of | Conc. Of | |
| | in | NaMetam | DGH in | DGH | K |
| Organism | combination | alone | combination | alone | value |
| Penicillum | 1.95 | 31.2 | 50 | 62.5 | 0.9 |
| pinophillum | | | | | |
| Aspergillus | 1.95 | 31.2 | 50 | 62.5 | 0.9 |
| niger | | | | | |
| Wild Strain - | 1.95 | 125 | 50 | 62.5 | 0.8 |
| Alternaria | | | | | |
| sp. | | | | | |
| Mixed | 1.95 | 250 | 50 | 62.5 | 0.8 |
| Inoculum | | | | | |

An especially effective ratio is 1 NaMetam:26 DGH

Such terms as “growth inhibiting,” “microbiocide” and “antimicrobial” are used herein both as terms of art and to indicate that the compositions claimed herein can inhibit the growth of the unitary and multiple cell organisms screened and otherwise within the classes of organisms described, which often are quite visible in their colony forms. Our invention is applicable in particular to inhibit the growth of organisms known as Protista in or on wallboard. The Protista comprise algae, fungi, slime molds, and protozoa; this includes a large number of growths which can be quite damaging to property, such as mildew, as well as unhealthful if sometimes not pathogenic to humans. Included within the category Protista are the phyla Chlorophyta, including green algae; Charophyta, including stoneworts; Euglenophyta (euglenoids); Chrysophyta, or golden-brown algae, including the classes Chrysophyceae, Xanthophyceai, and Bacillariophyceae; Pyrrophyta, including the classes Cryptophyceae and dinophyceae; Phaeopphyta (brown algae), and Rhodophyta (red algae). Also categorized within Protista are the fungi, i.e. the phylum Mycophyta, including the classes Phycomycetes, Ascomycetes, Basidiomycetes, and the so-called Fungi Imperfecti, which includes various types of fungi difficult to assign to a class. It should be noted here that lichens are also included as a target in our invention—they are symbiotic associations of algae and fungi. Our invention is also applicable to slime molds, the phylum Myxophyta, slime molds including the classes Myxomyceteae, Acrasieae, and Labyrinthuleae. In addition, the phylum Protozoa is included in Protista. This includes the subphyla Mastigophora, Sarcodinia, Sporozoa, and Ciliophora. We intend to include within our invention, as organisms whose growth and proliferation can be inhibited, all of the species within the above named phyla; that is, we intend to include in our definition of “microbes” or “microorganisms” all of the phyla mentioned above, and all of the species within the Protista; these are described in further detail in Chapter 12 of “The Science of Biology” by Paul B. Weisz, Third Edition.

Thus, it may be seen that our invention comprises a wallboard which inhibits the growth of microbes, the wallboard comprising a core body and at least one covering, the wallboard having incorporated therein an antimicrobial guanidine compound. In another aspect, our invention includes a method of making a mildew-resistant wallboard comprising adding an antimicrobial guanidine compound to at least one component of the wallboard during the manufacture of the wallboard. The core body may be predominantly gypsum or comprise substitute materials. The covering may be predominantly paper or comprise substitute materials. The antimicrobial guanidine compound may be the sole antimicrobial agent or may be accompanied by one or more other antimicrobial compounds, such as, for example, ortho phenyl phenol or its sodium salt, or sodium methyldithiocarbamate. The antimicrobial guanidine compound, alone or with another antimicrobial compound such as o-phenyl phenol or its sodium salt, or NaMetam, may be incorporated into the papermaking slurry, or incorporated by spraying or rolling (or calendering) during the formation of the paper, or sprayed or otherwise coated onto a finished covering before or after it is applied to the core body to become a facing or covering. The antimicrobial guanidine compound or the antimicrobial composite may be present throughout the wallboard or in any component thereof, including in an adhesive or other material at the interface of the core body and the covering, or simply on the surface of a covering. It will have a mildew-inhibiting effect commensurate with its concentration—that is, a very small amount will be effective to at least some degree. A convenient concentration for either the DGH alone or the antimicrobial composite is at least 10 parts per million. Notwithstanding that the antimicrobial guanidine compound or an antimicrobial composite as defined above will have a mildew-inhibiting effect commensurate with its concentration, we include especially antimicrobial composites having a synergistic effect—that is, which permit the inclusion of concentrations less than would be required by themselves to achieve an equivalent antimicrobial effect.

1. A wallboard which inhibits the growth of microbes, said wallboard comprising a gypsum core and at least one covering, said wallboard having incorporated therein an antimicrobial guanidine compound.

2. The wallboard of claim 1 wherein said antimicrobial guanidine compound comprises dodecyl guanidine hydrochloride.

3. The wallboard of claim 1 wherein said antimicrobial guanidine compound is present in said wallboard at a concentration of at least 10 parts by weight antimicrobial guanidine compound to one million parts by weight wallboard.

4. The wallboard of claim 1 wherein said covering is a paper covering and said antimicrobial guanidine compound is present in said paper covering.

5. The wallboard of claim 1 wherein said antimicrobial guanidine compound is present in said core body.

6. The wallboard of claim 1 wherein said antimicrobial guanidine compound is present on the surface of said covering.

7. The wallboard of claim 1 having an interface between said core body and said paper covering, and including a material capable of providing nourishment to microbes at said interface, and wherein said antimicrobial guanidine compound is also present at said interface.

8. The wallboard of claim 1 having also incorporated therein sodium methyldithiocarbamate.

9. The wallboard of claim 1 having also incorporated therein an antimicrobial phenolic compound.

10. The wallboard of claim 9 wherein said antimicrobial phenolic compound is ortho phenyl phenol or its sodium salt and is present in said wallboard in a total concentration of at least 10 parts by weight per million parts by weight of said wallboard.

11. The wallboard of claim 8 wherein said sodium methyldithiocarbamate and said antimicrobial guanidine compound are present in said wallboard in an antimicrobially synergistic ratio.

12. The wallboard of claim 9 wherein said antimicrobial guanidine compound and said antimicrobial phenolic compound are present in or on said covering.

13. The wallboard of claim 11 wherein said sodium methyldithiocarbamate and said antimicrobial guanidine compound are present in or on said covering.

14. The wallboard of claim 1 wherein said antimicrobial guanidine compound is dodecyl guanidine hydrochloride and wherein ortho phenyl phenol is also present in said wall board in an antimicrobially synergistic ratio to said dodecyl guanidine hydrochloride..

15. Wallboard of claim 1 wherein said core body comprises gypsum.

16. A method of making mildew-resistant wallboard comprising adding an antimicrobial guanidine compound to at least one component of said wallboard during the manufacture of said wallboard.

17. The method of claim 16 wherein said antimicrobial compound is dodecyl guanidine hydrochloride.

18. The method of claim 16 including adding a second antimicrobial additive to at least one component of said wallboard during the manufacture of said wallboard.

19. A method of making a mildew-resistant paper covering for wallboard comprising adding an antimicrobial guanidine compound to said paper during or after manufacture of said paper covering.

20. The method of claim 19 wherein said antimicrobial guanidine compound is dodecyl guanidine hydrochloride.
